(19) United States
(12) Patent Application Publication
(10) Pub. No.: US 2022/0397801 A1
(43) Pub. Date: Dec. 15, 2022

(54) LIGHT ROUTE CONTROL MEMBER AND DISPLAY HAVING THE SAME

(71) Applicant: LG INNOTEK CO., LTD., Seoul (KR)

(72) Inventors: Jin Gyeong PARK, Seoul (KR); Byung Sook KIM, Seoul (KR); Hyeon Ji HONG, Seoul (KR); Mun Yeong SON, Seoul (KR)

(21) Appl. No.: 17/754,362

(22) PCT Filed: Sep. 21, 2020
(86) PCT No.: PCT/KR2020/012726

§ 371 Date: Mar. 30, 2022

(30) Foreign Application Priority Data
Sep. 30, 2019 (KR) 10-2019-0120514
Oct. 8, 2019 (KR) 10-2019-0124568
Oct. 11, 2019 (KR) 10-2019-0126030

(51) Int. Cl. G02F 1/1677; G02F 1/167; G02F 1/1676

(52) U.S. Cl. CPC G02F 1/1677; G02F 1/167; G02F 1/1676

(57) ABSTRACT

An optical path control member, according to one embodiment, comprises: a first substrate; a first electrode disposed on the upper surface of the first substrate; a second substrate disposed above the first substrate; a second electrode disposed on the lower surface of the second substrate; and a light conversion unit disposed between the first electrode and the second electrode, wherein the light conversion unit comprises a partition wall part and an accommodation part which are alternately arranged. The accommodation part: has a light transmittance that varies according to the application of a voltage; comprises a dispersion liquid and a plurality of light-absorbing particles dispersed in the dispersion liquid; and has at least one protrusion part arranged therein. The protrusion part: makes contact with the partition wall part; and is extendedly arranged in a direction different from the extending direction of the partition wall part.

### CROSS-REFERENCE TO RELATED APPLICATIONS

This application is the U.S. national stage application of International Patent Application No. PCT/KR2020/012726, filed Sep. 21, 2020, which claims the benefit under 35 U.S.C. § 119 of Korean Application Nos. 10-2019-0120514, filed Sep. 30, 2019; 10-2019-0124568, filed Oct. 8, 2019; and 10-2019-0126030, filed Oct. 11, 2019; the disclosures of each of which are incorporated herein by reference in their entirety.

### TECHNICAL FIELD

An embodiment relates to a light route control member and display having the same having improved reliability and a display device including the same.

### BACKGROUND ART

A light-shielding film shields transmitting of light from a light source, and is attached to a front surface of a display panel which is a display device used for a mobile phone, a notebook, a tablet PC, a vehicle navigation device, a vehicle touch, etc., so that the light-shielding film adjusts a viewing angle of light according to an incident angle of light to express a clear image quality at a viewing angle needed by a user when the display transmits a screen.

In addition, the light-shielding film may be used for the window of a vehicle, building or the like to shield outside light partially to inhibit glare, or to inhibit the inside from being visible from the outside.

That is, the light-shielding film may be a light route control member that controls a movement path of light, block light in a specific direction, and transmit light in a specific direction. Accordingly, by controlling the light transmission angle by the light-shielding film, it is possible to control the viewing angle of the user.

Meanwhile, such a light-shielding film may be a light-shielding film that can always control the viewing angle regardless of the surrounding environment or the user's environment, and switchable light-shielding film that allows the user to turn on/off the viewing angle control according to the surrounding environment or the user's environment may be distinguished.

Meanwhile, the switchable light-shielding film having such an on-off function is converted into a transmissive unit and a light blocking unit according to on-off through movement of particles moving by the application of voltage to control a user's viewing angle.

These particles may be dispersed and disposed inside the dispersion. Such a light-shielding film may be applied to be fixed or detachable to the screen of the display.

For example, when the light-shielding film is applied to a notebook computer, the light-shielding film is placed in a lying state before use. In addition, during use, the light-shielding film is inclined at an angle of 45° to 135° like a laptop screen.

Accordingly, there is a need for a light route control member having a new structure capable of solving the above problems.

### DISCLOSURE

### Technical Problem

An embodiment is to provide a light route control member capable of suppressing the settling of light absorbing particles in the gravitational direction.

### Technical Solution

A light route control member according to embodiment includes a first substrate, a first electrode disposed on an upper surface of the first substrate, a second substrate disposed on the first substrate, a second electrode disposed on a lower surface of the second substrate and a light conversion unit disposed between the first electrode and the second electrode, and the light conversion unit includes a partition wall unit and a receiving unit that are alternately disposed, and the receiving unit includes a dispersion and a plurality of light absorbing particles dispersed in the dispersion, and at least one protrusion is disposed inside the receiving unit, and the protrusion is disposed to extend in a direction different from the direction in which the partition wall unit extends.

### Advantageous Effects

A light route control member according to an embodiment includes at least one protrusion disposed inside the receiving unit.

When the light route control member is used upright by the protrusion, it is possible to inhibit the light absorbing particles inside the receiving unit from moving downward and being aggregated in one area. Accordingly, it is possible to inhibit the dispersibility of the light absorbing particles from being reduced due to the aggregation of the light absorbing particles in one region. Thereby, even when the light route control member is driven for a long time, the viewing angle control characteristic of the light route control member can be maintained.

Further, by the protrusion, it is possible to control the viewing angles in the left-right direction and the up-down direction. That is, the light route control member can control the viewing angles in four directions.

That is, the protrusion includes a plurality of protrusions extending in different directions. Thereby, since the extending direction of the receiving unit also extends in two directions, it is possible to control the viewing angles in four directions in the vertical and horizontal directions according to the respective extending directions.

In addition, the light route control member according to the embodiment includes a filter layer disposed on one end and the other end of the receiving unit.

The filter layer may selectively permeate the material according to the phase of the material. That is, the filter layer may block liquid substances and transmit gaseous substances.

Accordingly, when the dispersion is injected into the receiving unit, air can be discharged while sealing the dispersion by the filter layer disposed in the direction of the outlet.

Accordingly, it is possible to inhibit the formation of an air layer generated while injecting the dispersion into the receiving unit. That is, by discharging the air generated during the injection process to the outside by the filter layer, it is possible to remove the air layer that may be formed inside the receiving unit.

Accordingly, in the light route control member according to the embodiment, the dispersion may be stably filled in the receiving unit to improve filling properties. Accordingly, by improving the filling properties of the receiving unit, the light route control characteristic can be improved, and the characteristic of a display device including the same can be improved.

In addition, the light route control member according to the embodiment seals the dispersion exposed by the injection part and the outlet part only on one surface of the receiving unit.

Conventionally, the injection part is disposed on one surface of the receiving unit, and the outlet part is disposed on the other surface opposite to the one surface. That is, the injection part and the outlet part were respectively disposed on two surfaces of the receiving unit. Accordingly, sealing layers for sealing the injection part and the outlet part were also disposed on both surfaces of the receiving unit.

Accordingly, there is a problem in that the bezel area of the light route control member is widened.

Accordingly, in the light route control member according to the embodiment, the injection part and the outlet part are disposed on one side of the receiving unit, and after all the dispersion is injected into the receiving unit, a sealing layer is formed on only one side of the receiving unit. Therefore, the bezel area can be reduced.

In addition, the receiving unit may include a first receiving unit extending in a first direction and a second receiving unit extending in a second direction different from the first direction. For example, the first direction and the second direction may be perpendicular to each other.

By disposing the receiving unit in the first and second directions, that is, in the horizontal and vertical directions, the viewing angle of the light route control member can be controlled in four directions. That is, the viewing angle in the left-right direction can be controlled by the receiving unit extending in the first direction, and the viewing angle in the up-down direction can be controlled by the left-right direction extending in the second direction. Accordingly, it is possible to limit the viewing angle of the light route control member in four directions without further forming a separate light conversion unit.

### DESCRIPTION OF DRAWINGS

FIG. 1 is a view showing a perspective view of a light route control member according to an embodiment.

FIGS. 2 and 3 are views showing a perspective view of a first substrate and a first electrode, and a second substrate and a second electrode of the light route control member according to the embodiment, respectively.

FIGS. 4 and 5 are views showing a cross-sectional view of a light route control member according to embodiment.

FIGS. 6 and 7 are a view for showing a state before and after use of the light conversion unit of the light route control member according to the embodiment.

FIGS. 8 to 19 are views showing a perspective view and a top view of a partition wall unit of a light conversion unit in the light route control member according to the embodiment.

FIGS. 20 to 23 are views showing other cross-sectional view of a light route control member according to embodiment.

FIG. 24 is views showing a top view of a light route control member according to another embodiment.

FIG. 25 is view showing a cross-sectional view taken along line A-A′ of FIG. 24.

FIGS. 26 to 28 are views showing a top view of a light route control member according to another embodiment.

FIGS. 29 to 34 are views for explaining a process in which a dispersion is injected in area B of FIG. 26.

FIG. 35 is a cross-sectional view of a display device to which a light route control member according to an embodiment is applied.

FIGS. 36 and 37 are views for describing one embodiment of the display device to which the light route control member according to the embodiment is applied.

### MODES OF THE INVENTION

Hereinafter, embodiments of the present invention will be described in detail with reference to the accompanying drawings. However, the spirit and scope of the present invention is not limited to a part of the embodiments described, and may be implemented in various other forms, and within the spirit and scope of the present invention, one or more of the elements of the embodiments may be selectively combined and replaced.

In addition, unless expressly otherwise defined and described, the terms used in the embodiments of the present invention (including technical and scientific terms) may be construed the same meaning as commonly understood by one of ordinary skill in the art to which this invention belongs, and the terms such as those defined in commonly used dictionaries may be interpreted as having a meaning that is consistent with their meaning in the context of the relevant art.

In addition, the terms used in the embodiments of the present invention are for describing the embodiments and are not intended to limit the present invention. In this specification, the singular forms may also include the plural forms unless specifically stated in the phrase, and may include at least one of all combinations that may be combined in A, B, and C when described in “at least one (or more) of A (and), B, and C”.

Further, in describing the elements of the embodiments of the present invention, the terms such as first, second, A, B, (a), and (b) may be used. These terms are only used to distinguish the elements from other elements, and the terms are not limited to the essence, order, or order of the elements.

In addition, when an element is described as being “connected”, “coupled”, or “connected” to another element, it may include not only when the element is directly “connected” to, “coupled” to, or “connected” to other elements, but also when the element is “connected”, “coupled”, or “connected” by another element between the element and other elements.

Further, when described as being formed or disposed “on (over)” or “under (below)” of each element, the “on (over)” or “under (below)” may include not only when two elements are directly connected to each other, but also when one or more other elements are formed or disposed between two elements.

Furthermore, when expressed as “on (over)” or “under (below)”, it may include not only the upper direction but also the lower direction based on one element.

Hereinafter, a light route control member according to an embodiment will be described with reference to drawings. The light route control member described below relates to a switchable light route control member that drives in various modes according to the movement of electrophoretic particles application of a voltage.

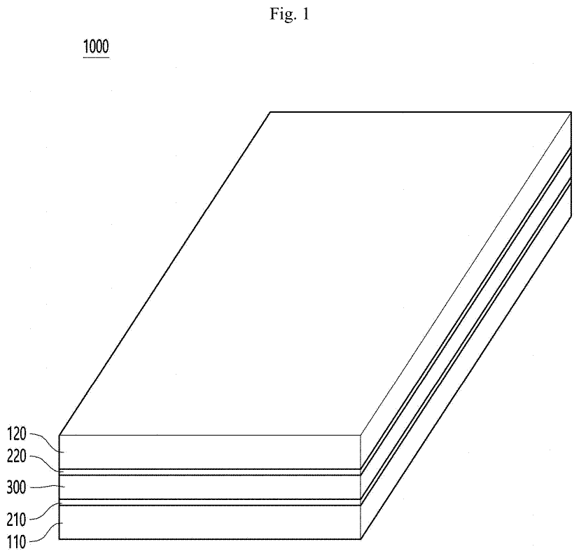

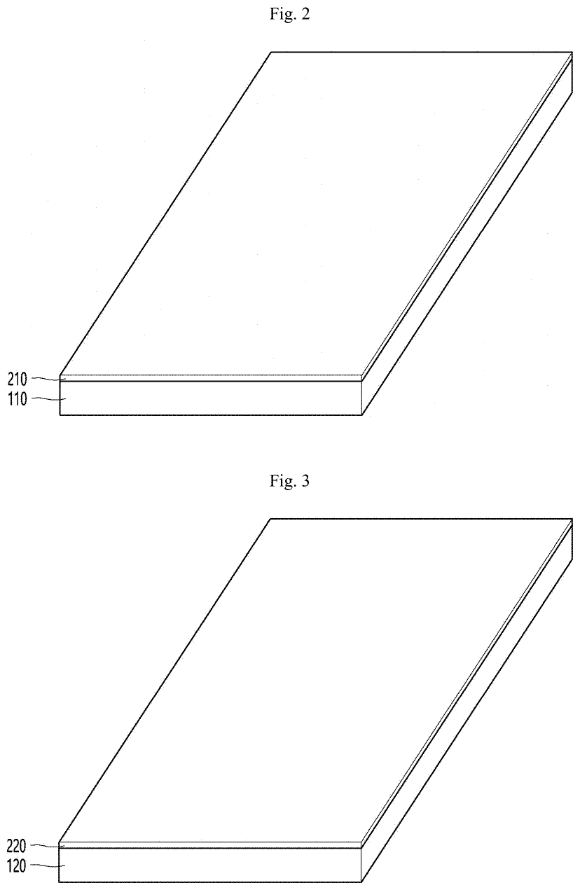

Referring to FIGS. 1 to 3, a light route control member according to an embodiment may include a first substrate 110, a second substrate 120, a first electrode 210, a second electrode 220, and a light conversion unit 300.

The first substrate 110 may support the first electrode 210. The first substrate 110 may be rigid or flexible.

In addition, the first substrate 110 may be transparent. For example, the first substrate 110 may include a transparent substrate capable of transmitting light.

The first substrate 110 may include glass, plastic, or a flexible polymer film. For example, the flexible polymer film may be made of any one of polyethylene terephthalate (PET), polycarbonate (PC), acrylonitrile-butadiene-styrene copolymer (ABS), polymethyl methacrylate (PMMA), polyethylene naphthalate (PEN), polyether sulfone (PES), cyclic olefin copolymer (COC), triacetylcellulose (TAC) film, polyvinyl alcohol (PVA) film, polyimide (PI) film, and polystyrene (PS), which is only an example, but the embodiment is not limited thereto.

In addition, the first substrate 110 may be a flexible substrate having flexible characteristics.

Further, the first substrate 110 may be a curved or bended substrate. That is, the light route control member including the first substrate 110 may also be formed to have flexible, curved, or bent characteristics. Accordingly, the light route control member according to the embodiment may be changed to various designs.

The first substrate 110 may have a thickness of 30 um to 100 um.

The first electrode 210 may be disposed on one surface of the first substrate 110. In detail, the first electrode 210 may be disposed on an upper surface of the first substrate 110. That is, the first electrode 210 may be disposed between the first substrate 110 and the second substrate 120.

The first electrode 210 may contain a transparent conductive material. For example, the first electrode 210 may contain a metal oxide such as indium tin oxide, indium zinc oxide, copper oxide, tin oxide, zinc oxide, titanium oxide, etc.

The first electrode 210 may be disposed on the first substrate 110 in a film shape. In detail, light transmittance of the first electrode 210 may be about 80% or more.

The first electrode 210 may have a thickness of about 0.1 um to about 0.5 um.

Alternatively, the first electrode 210 may contain various metals to realize low resistance. For example, the first electrode 210 may contain at least one metal of chromium (Cr), nickel (Ni), copper (Cu), aluminum (Al), silver (Ag), molybdenum (Mo). gold (Au), titanium (Ti), and alloys thereof.

The first electrode 210 may be disposed on the entire surface of one surface of the first substrate 110. That is, the first electrode 210 may be disposed on the first substrate 110 in the shape of a surface electrode.

In addition, the first electrode 210 may include a plurality of conductive patterns. For example, the first electrode 210 may include a plurality of mesh lines intersecting each other and a plurality of mesh openings formed by the mesh lines.

Accordingly, even though the first electrode 210 contains a metal, visibility may be improved because the first electrode is not visible from the outside. In addition, the light transmittance is increased by the openings, so that the brightness of the light route control member according to the embodiment may be improved.

The second substrate 120 may be disposed on the first substrate 110. In detail, the second substrate 120 may be disposed on the first electrode 210 on the first substrate 110.

The second substrate 120 may contain a material capable of transmitting light. The second substrate 120 may contain a transparent material. The second substrate 120 may contain a material the same as or similar to that of the first substrate 110 described above.

For example, the second substrate 120 may include glass, plastic, or a flexible polymer film. For example, the flexible polymer film may be made of any one of polyethylene terephthalate (PET), polycarbonate (PC), acrylonitrile-butadiene-styrene copolymer (ABS), polymethyl methacrylate (PMMA), polyethylene naphthalate (PEN), polyether sulfone (PES), cyclic olefin copolymer (COC), triacetylcellulose (TAC) film, polyvinyl alcohol (PVA) film, polyimide (PI) film, and polystyrene (PS), which is only an example, but the embodiment is not limited thereto.

In addition, the second substrate 120 may be a flexible substrate having flexible characteristics.

Further, the second substrate 120 may be a curved or bended substrate. That is, the light route control member including the second substrate 120 may also be formed to have flexible, curved, or bent characteristics. Accordingly, the light route control member according to the embodiment may be changed to various designs.

The second substrate 120 may have a thickness of 30 um to 100 um.

The second electrode 220 may be disposed on one surface of the second substrate 120. In detail, the second electrode 220 may be disposed on a lower surface of the second substrate 120. That is, the second electrode 220 may be disposed on a surface on which the second substrate 120 faces the first substrate 110. That is, the second electrode 220 may be disposed facing the first electrode 210 on the first substrate 110. That is, the second electrode 220 may be disposed between the first electrode 210 and the second substrate 120.

The second electrode 220 may contain a transparent conductive material. For example, the second electrode 220 may contain a metal oxide such as indium tin oxide, indium zinc oxide, copper oxide, tin oxide, zinc oxide, titanium oxide, etc.

The second electrode 220 may be disposed on the first substrate 110 in a film shape. In addition, the light transmittance of the second electrode 220 may be about 80% or more.

The second electrode 220 may have a thickness of about 0.1 um to about 0.5 um.

Alternatively, the second electrode 220 may contain various metals to realize low resistance. For example, the second electrode 220 may contain at least one metal of chromium (Cr), nickel (Ni), copper (Cu), aluminum (Al), silver (Ag), molybdenum (Mo). gold (Au), titanium (Ti), and alloys thereof.

The second electrode 220 may be disposed on the entire surface of one surface of the second substrate 120. In detail, the second electrode 220 may be disposed as a surface electrode on one surface of the second substrate 120.

In addition, the second electrode 220 may include a plurality of conductive patterns. For example, the second electrode 220 may include a plurality of mesh lines intersecting each other and a plurality of mesh openings formed by the mesh lines.

Accordingly, even though the second electrode 220 contains a metal, visibility may be improved because the second electrode 220 is not visible from the outside. In addition, the light transmittance is increased by the openings, so that the brightness of the light route control member according to the embodiment may be improved.

The light conversion unit 300 may be disposed between the first substrate 110 and the second substrate 120. In detail, the light conversion unit 300 may be disposed between the first electrode 210 and the second electrode 220.

The light conversion unit 300 may be bonded to the first electrode 210 and the second electrode 220. For example, a buffer layer for improving adhesion with the light conversion unit 300 is disposed on the first electrode 210, and the first electrode 210 and the light conversion unit 300 may be formed through the buffer layer. In addition, an adhesive layer 400 for adhesion to the light conversion unit 300 is disposed under the second electrode 220, and the second electrode 220 and the light conversion unit 300 may be adhered to each other through the adhesive layer 400.

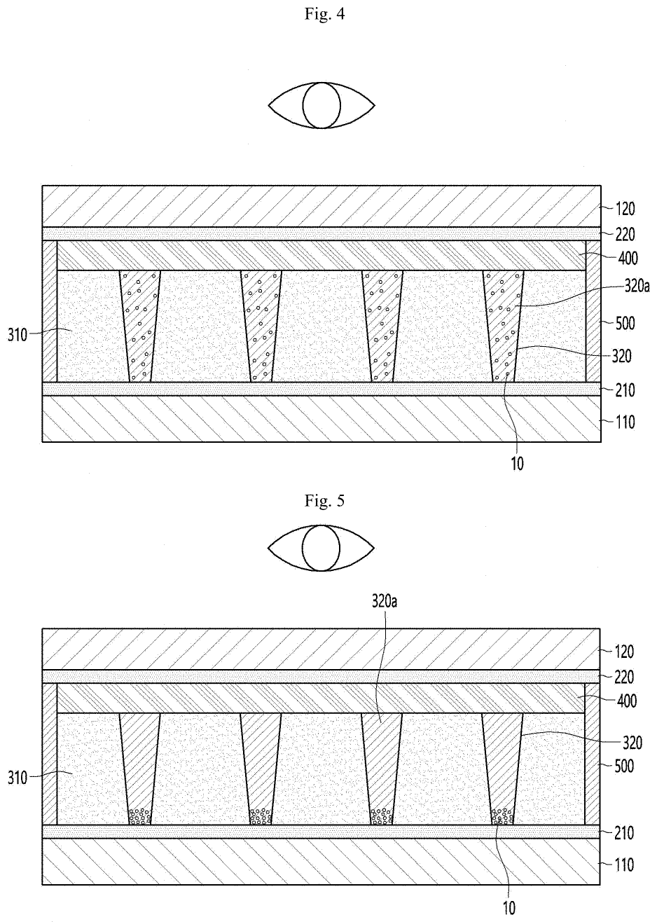

Referring to FIGS. 4 to 7, the light conversion unit 300 may include a partition wall unit 310 and a receiving unit 320. The partition wall unit 310 may be defined as a partition wall unit region that partitions the light transmitting portion. That is, the partition wall unit 310 is a partition wall unit region that partitions a plurality of light transmitting portions. The partition wall unit 310 may be formed in an embossed shape.

In addition, the receiving unit 320 may be defined as a region that changes into a light blocking part and a light transmitting part according to the application of a voltage. The receiving unit 320 may be formed in an engraved shape. That is, the receiving unit 320 may be formed in an engraved shape formed between two adjacent embossed partition wall units 310.

The partition wall unit 310 and the receiving unit 320 may be alternately disposed. In detail, the partition wall unit 310 and the receiving unit 320 may be alternately disposed. That is, each of the partition wall units 310 may be disposed between the receiving units 320 adjacent to each other, and each of the receiving units 320 may be disposed between the partition wall units 310 adjacent to each other.

The partition wall unit 310 may contain a transparent material. The partition wall unit 310 may contain a material that may transmit light.

The partition wall unit 310 may contain a resin material. For example, the partition wall unit 310 may contain a photo-curable resin material. As an example, the partition wall unit 310 may contain a UV resin or a transparent photoresist resin. Alternatively, the partition wall unit 310 may contain urethane resin or acrylic resin.

The partition wall unit 310 may transmit light incident on any one of the first substrate 110 and the second substrate 120 toward another substrate.

For example, in FIGS. 4 and 5, light may be emitted in a direction of the first substrate 110 and the light may be incident in the direction of the second substrate 120. The partition wall unit 310 may transmit the light, and the transmitted light may be moved in a direction of the second substrate 120.

A sealing part 500 sealing the light route control member may be disposed on a side surface of the partition wall unit. And a side surface of the light conversion unit 300 may be sealed by the sealing part.

The receiving units 320 may include the dispersion 320a and the light absorbing particles 10 described above. In detail, the receiving unit 320 is filled with the dispersion 320a, and a plurality of the light absorbing particles 10 may be dispersed in the dispersion 320a.

The dispersion 320a may be a material for dispersing the light absorbing particles 10. The dispersion 320a may contain a transparent material. The dispersion 320a may contain a non-polar solvent. In addition, the dispersion 320a may contain a material capable of transmitting light. For example, the dispersion 320a may include at least one of a halocarbon-based oil, a paraffin-based oil, and isopropyl alcohol.

The light absorbing particles 10 may be disposed to be dispersed in the dispersion 3201. In detail, the plurality of light absorbing particles 10 may be disposed to be spaced apart from each other in the dispersion 320a.

The light absorbing particle 20 may have an electric charge on the particle surface. Accordingly, when a voltage is applied to the light route control member, the light absorbing particles 10 may move in the dispersion 320a.

The light absorbing particles 10 may include a material having a color. The light absorbing particles 10 may include a material that absorbs light. In detail, the light absorbing particles 10 may include a black light absorbing material. For example, the light absorbing particles 10 may include carbon black particles.

The light transmittance of the receiving unit 320 may be changed by the light absorbing particles 10. In detail, the receiving unit 320 may be changed into the light blocking part and the light transmitting part by changing the light transmittance due to the light absorbing particles 10.

For example, the light route control member according to the embodiment may be changed from a first mode to a second mode or from the second mode to the first mode by a voltage applied to the first electrode 210 and the second electrode 220.

In detail, in the light route control member according to the embodiment, the receiving unit 320 becomes the light blocking part in the first mode, and light of a specific angle may be blocked by the receiving unit 320. That is, a viewing angle of the user viewing from the outside may be narrowed.

In addition, in the light route control member according to the embodiment, the receiving unit 320 becomes the light transmitting part in the second mode, and in the light route control member according to the embodiment, light may be transmitted through both the partition wall unit 310 and the receiving unit 320. That is, the viewing angle of the user viewing from the outside may be widened.

Switching from the first mode to the second mode, that is, the conversion of the receiving unit 320 from the light blocking part to the light transmitting part may be realized by movement of the light absorbing particles 10 of the receiving unit 320. Thai is, the light absorbing particle 10 has a charge on the surface, and may be moved in the direction of the first electrode or the second electrode by the application of a voltage according to the characteristics of the charge. That is, the light absorbing particle 10 may be an electrophoretic particle.

In detail, the receiving unit 320 may be electrically connected to the first electrode 210 and the second electrode 220.

In this case, when a voltage is not applied to the light route control member from the outside, the light absorbing particles 10 of the receiving unit 320 are uniformly dispersed in the dispersion 320a, and light may be blocked by the light conversion particles in the receiving unit 320. Accordingly, in the first mode, the receiving unit 320 may be driven as the light blocking part.

Alternatively, when a voltage is applied to the light route control member from the outside, the light absorbing particles 10 may move. For example, the light absorbing particles 10 may move toward one end or the other end of the receiving unit 320 by a voltage transmitted through the first electrode 210 and the second electrode 220. That is, the light absorbing particles 10 may move from the receiving unit 320 toward the first electrode or the second electrode.

In detail, when a voltage is applied to the first electrode 210 and/or the second electrode 220, an electric field is formed between the first electrode 210 and the second electrode 220, and the charged carbon black, that is, the light absorbing particles may be moved toward a positive electrode of the first electrode 210 and the second electrode 220 using the dispersion 320a as a medium.

That is, when the voltage is not applied to the first electrode 210 and/or the second electrode 220, as shown in FIG. 4, the light absorbing particles 10 may be uniformly dispersed in the dispersion 320a to drive the receiving unit 320 as the light blocking part.

In addition, when the voltage is applied to the first electrode 210 and/or the second electrode 220, as shown in FIG. 5, the light absorbing particles 10 may be moved toward the first electrode 210 in the dispersion 320a. That is, the light absorbing particles 10 are moved in one direction, and the receiving unit 320 may be driven as the light transmitting part

Accordingly, the light route control member according to the embodiment may be driven in two modes according to a user's surrounding environment. That is, when the user requires light transmission only at a specific viewing angle, the receiving unit is driven as the light blocking part, or in an environment in which the user requires high brightness, a voltage may be applied to drive the receiving unit as the light transmitting part.

Therefore, since the light route control member according to the embodiment may be implemented in two modes according to the user's requirement, the light route control member may be applied regardless of the user's environment.

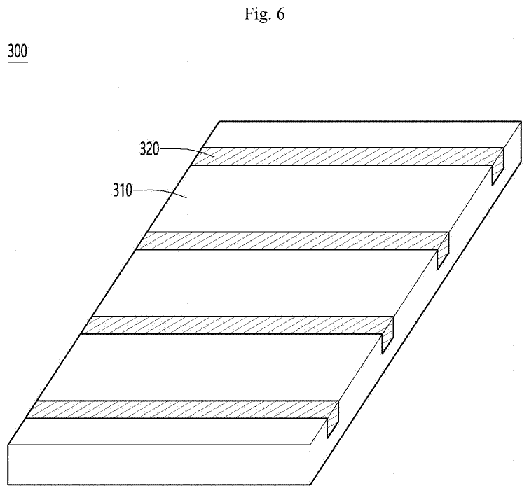

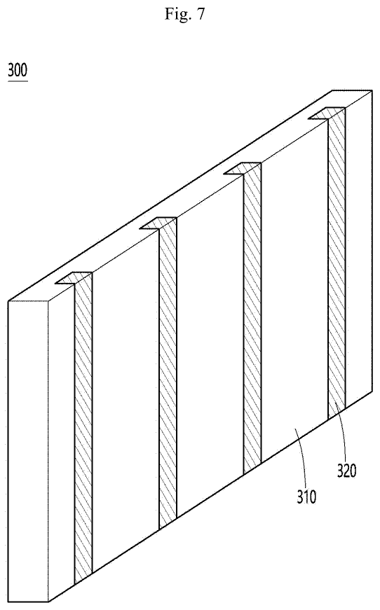

Meanwhile, referring to FIGS. 6 and 7, the arrangement position of the light conversion unit 300 may vary depending on before and after use of the light route control member. In detail, before using the light route control member, the light conversion unit 300 may be disposed in a lying state as shown in FIG. 6. That is, when viewed from the top, one surface of the light conversion unit 300 adhering to the adhesive layer 400 may be visible.

However, when the light route control member is used, the light conversion unit 300 may be inclined at an angle of about 45° to 135°. For example, as shown in FIG. 7, the light conversion unit may be inclined at an angle of about 90°. That is, when viewed from the top, the side of the light conversion unit, that is, one side of the sealing unit 500 may be visible.

In this case, when using for a long time or storing the light route control member in a used state, the light absorbing particles 10 inside the receiving unit 320 may be sedimented in the gravity direction, that is, downward by gravity. Accordingly, according to the use time, the dispersibility of the light absorbing particles 10 may be reduced, and the characteristics of the light route controlling member may be reduced.

Accordingly, in the light route controlling member according to the embodiment, a plurality of protrusions for inhibiting the light absorbing particles 10 from being deposited may be formed in the receiving unit 320.

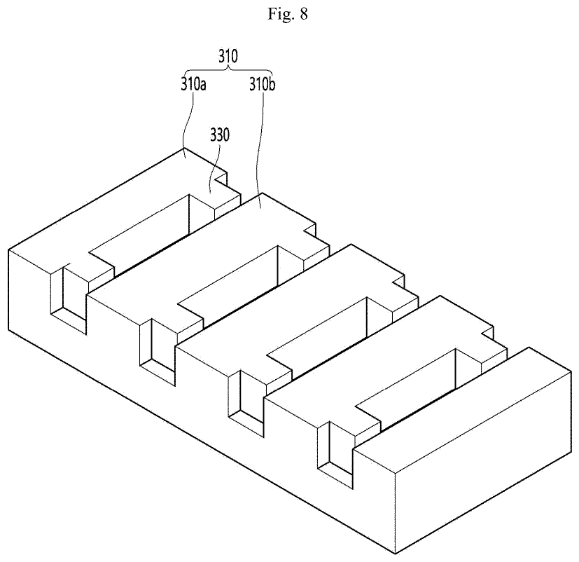

FIGS. 8 to 21 are perspective views and top views of the partition wall unit 310 and the receiving unit 320 of the light conversion unit 300. In detail, FIGS. 8 to 21 are perspective views and top views of the partition wall unit 310 and the receiving unit 320 before the dispersion is filled in the receiving unit of the light conversion unit 300.

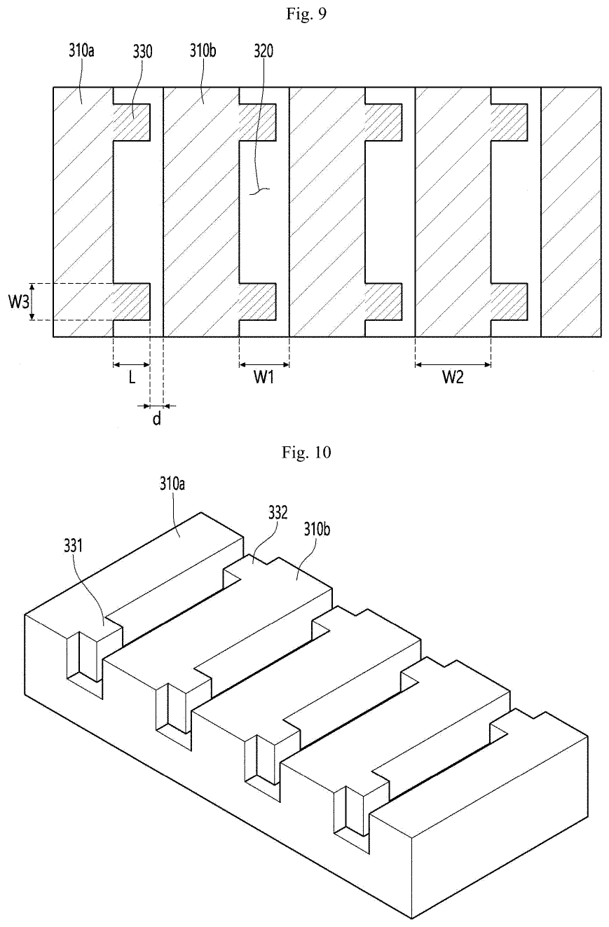

Referring to FIGS. 8 and 9, a plurality of protrusions 330 may be disposed inside the receiving unit 320. In detail, a plurality of protrusions 330 connected to the partition wall unit 310 may be disposed inside the receiving unit 320

The protrusion 330 may be disposed at the same height as the partition wall unit 310. Also, the length L of the protrusion 330 may be smaller than the width w1 of the receiving unit 320. That is, the length L of the protrusion 330, which is defined as a distance extended by the protrusion 330, may be smaller than the width w1 of the receiving unit 320.

That is, the length L of the protrusion 330 may be smaller than the width w1 of the receiving unit 320 so that the region of the receiving unit 320 is not closed by the protrusion 330.

In addition, the width w3 of the protrusion 330 in the same direction in which the partition wall unit 310 extends is equal to or greater than the width w1 of the receiving unit, and is equal to or less than the sum of the width w1 of the receiving unit and the width w2 of the partition wall unit.

When the size of the width w3 of the protrusion 330 is less than the width w1 of the receiving unit, the reliability of the protrusion may be reduced due to the weakening of the supporting force of the protrusion. In addition, when the width w3 of the protrusion 330 exceeds the sum of the width w1 of the receiving unit and the width w2 of the partition wall unit, the size of the receiving unit is reduced, and the dispersion injected and the amount of light absorbing particles may be reduced.

The protrusion part 330 may be formed to extend from the first partition wall unit 310a in the direction of the second partition wall unit 310b adjacent to the first partition wall unit 310a. In detail, the protrusion 330 may extend in a direction in which the partition wall unit 310 extends, that is, in a direction different from the longitudinal direction. For example, the protrusion 330 may extend in a direction perpendicular to the direction in which the partition wall unit 310 extends, but the embodiment is not limited thereto.

The protrusion part 330 may be in contact with the first partition wall unit 310a and may be disposed to be spaced apart from the second partition wall unit 310b. That is, the protrusion part 330 may be disposed to be spaced apart from the second partition wall unit 310b by a predetermined distance. In detail, the distance between the protrusion 330 and the second partition wall unit 310b may be 10% to 50% of the width of the receiving unit 320.

When the distance between the protrusion 330 and the second partition wall unit 310b is less than 10% of the width of the receiving unit 320, since the inner region of the receiving unit 320 is narrowed by the region where the protrusion 330 is disposed, it may be difficult to inject the dispersion, and the movement speed of the particles may be reduced. In addition, when the distance between the protrusion 330 and the second partition wall unit 310b is exceeds 50% of the width of the receiving unit 320, the effect of inhibiting precipitation of the light absorbing particles by the protrusion may be reduced.

The protrusion 330 may include the same material as that of the first partition wall unit 310a. That is, the protrusion 330 may include a light-transmitting material. Also, the protrusion 330 and the first partition wall unit 310a may be integrally formed.

However, the embodiment is not limited thereto, and the protrusion 330 may include a material different from that of the partition wall unit 310, and the protrusion 330 and the partition wall unit 310 may be formed separately from each other.

At least one protrusion 330 may be formed inside the receiving unit 320. In detail, one or a plurality of the protrusions 330 may be disposed inside the receiving unit. That is, the protrusion 330 may include a plurality of protrusions spaced apart from each other by a predetermined distance. A distance between the plurality of protrusions may be 1 to 20 times the width w1 of the receiving unit.

When the distance between the plurality of protrusions is less than one time the width w1 of the receiving unit, the area in which the protrusions are formed becomes too large, and the dispersibility of the light absorbing particles may be reduced, and when the distance between the plurality of protrusions is exceeds 20 times the width w1 of the receiving unit, the effect of inhibiting precipitation of the light absorbing particles may be reduced.

When the light route control member is used by the protrusion 330, it is possible to inhibit the light absorbing particles inside the receiving unit from moving downward and being aggregated in one area. Accordingly, it is possible to inhibit the light absorbing particles from being agglomerated in one region, thereby reducing the dispersibility of the light absorbing particles, so that the viewing angle control characteristic of the light route control member can be maintained even when the light route control member is driven for a long time.

Referring to FIGS. 10 and 11, a plurality of protrusions may be disposed inside the receiving unit 320. In detail, a plurality of protrusions connected to the partition wall unit 310 may be disposed inside the receiving unit 320.

The protrusion may include a first protrusion 331 and a second protrusion 332. In detail, the protrusion 330 includes a first protrusion 331 extending from the first partition wall unit 310a to the second partition wall unit 310b adjacent to the first partition wall unit 310a, and a second protrusion 332 extending from the second partition wall unit 310b to the first partition wall unit 310a adjacent to the second partition wall unit 310b.

In detail, the first protrusion 331 and the second protrusion 332 may extend in a direction in which the partition wall unit 310 extends, that is, in a direction different from the longitudinal direction. For example, the first protrusion 331 and the second protrusion 332 may extend in a direction perpendicular to the direction in which the partition wall unit 310 extends, but the embodiment is not limited thereto.

The first protrusion 331 and the second protrusion 332 may be disposed at the same height as the partition wall unit 310. In addition, the first protrusion 331 and the second protrusion 332 may be disposed to have a length smaller than the width of the receiving unit 320. That is, in order to inhibit the receiving unit 320 area from being closed by the first protrusion 331 and the second protrusion 332, the length of the first and second protrusions may be smaller than the width of the receiving unit 320.

The first protrusion 331 may be in contact with the first partition wall unit 310a and may be disposed to be spaced apart from the second partition wall unit 310b. In addition, the second protrusion 332 may be in contact with the second partition wall unit 310b and may be disposed to be spaced apart from the first partition wall unit 310a.

The first protrusion 331 and the second protrusion 332 may be disposed at positions that do not overlap each other within the receiving unit 320. For example, the first protrusion 331 does not overlap the second protrusion 332 in a direction in which the first protrusion 331 extends. And, the second protrusion 332 does not overlap the first protrusion 331 in a direction in which the second protrusion 332 extends.

The first protrusion 331 and the second protrusion 332 may include the same material as the partition wall unit 310. That is, the first protrusion 331 and the second protrusion 332 may include a light-transmitting material. Also, the first protrusion 331 and the second protrusion 332 may be integrally formed with the partition wall unit 310.

However, the embodiment is not limited thereto, and the protrusion part may include a material different from that of the partition wall unit 310, and the protrusion part and the partition wall unit 310 may be formed separately from each other.

At least one of the first protrusion 331 and the second protrusion 332 may be formed in the receiving unit 320. In detail, one or a plurality of the first protrusion 331 and the second protrusion 332 may be disposed inside the receiving unit.

Due to the first protrusion 331 and the second protrusion 332, the light route control member may inhibit the light absorbing particles inside the receiving unit from moving downward and being aggregated in one area during use. Accordingly, it is possible to inhibit the dispersibility of the light absorbing particles from being reduced due to the aggregation of the light absorbing particles in one region. Thereby, even when the light route control member is driven for a long time, the viewing angle control characteristic of the light route control member can be maintained.

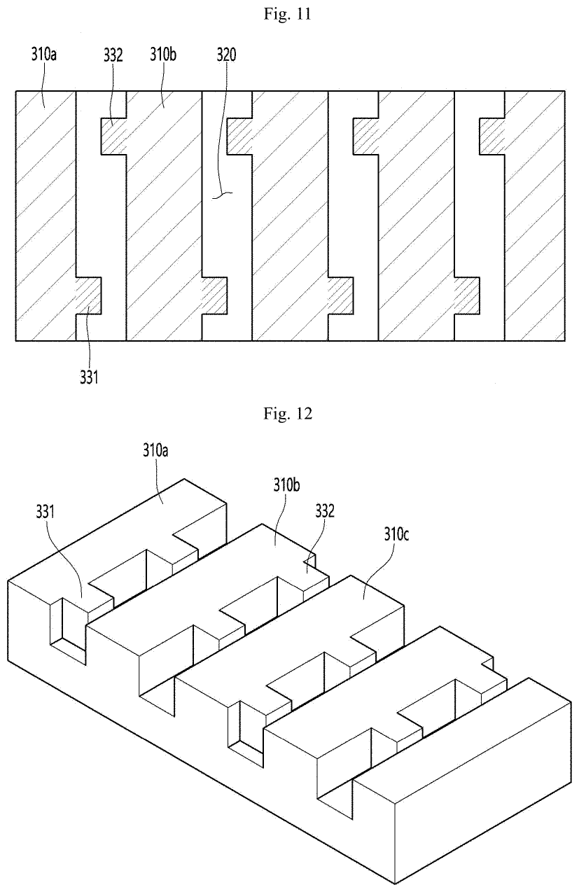

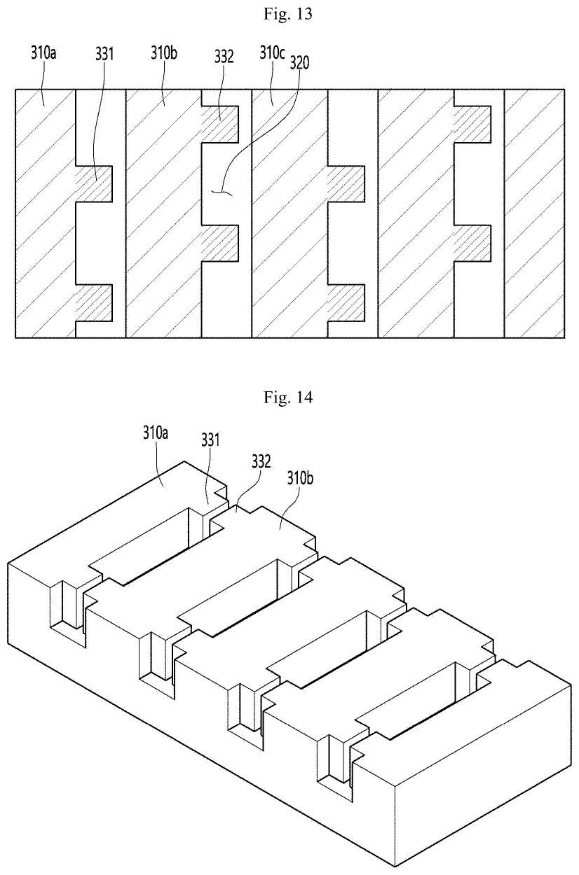

Referring to FIGS. 12 and 13, a plurality of protrusions may be disposed inside the receiving unit 320. In detail, a plurality of protrusions connected to the partition wall unit 310 may be disposed inside the receiving unit 320.

The protrusion 330 may include a first protrusion 331 and a second protrusion 332. In detail, the protrusion 330 includes a first protrusion 331 extending from the first partition wall unit 310a to the second partition wall unit 310b adjacent to the first partition wall unit 310a, and a second protrusion 332 extending from the second partition wall unit 310b to the third partition wall unit 310c adjacent to the second partition wall unit 310b.

In detail, the first protrusion 331 and the second protrusion 332 may extend in a direction in which the partition wall unit 310 extends, that is, in a direction different from the longitudinal direction. For example, the first protrusion 331 and the second protrusion 332 may extend in a direction perpendicular to the direction in which the partition wall unit 310 extends, but the embodiment is not limited thereto.

The first protrusion 331 and the second protrusion 332 may be disposed at the same height as the partition wall unit 310. In addition, the first protrusion 331 and the second protrusion 332 may be disposed to have a length smaller than the width of the receiving unit 320. That is, in order to inhibit the receiving unit 320 from being closed by the first protrusion 331 and the second protrusion 332, the first protrusion 331 and the second protrusion 332 has a length smaller than the width of the receiving unit 320.

The first protrusion 331 may be in contact with the first partition wall unit 310a and may be disposed to be spaced apart from the second partition wall unit 310b. In addition, the second protrusion 332 may be in contact with the second partition wall unit 310b and may be disposed to be spaced apart from the third partition wall unit 310c.

The first protrusion 331 and the second protrusion 332 may be disposed at positions that do not overlap each other within each of the receiving units 320. For example, the first protrusion 331 does not overlap the second protrusion 332 in a direction in which the first protrusion 331 extends, and the second protrusion 332 does not overlap the first protrusion 331 in a direction in which the second protrusion 332 extends.

In detail, the first protrusion 331 and the second protrusion 332 may be disposed in a zigzag shape inside the receiving unit 320.

The first protrusion 331 and the second protrusion 332 may include the same material as the partition wall unit 310. That is, the first protrusion 331 and the second protrusion 332 may include a light-transmitting material. Also, the first protrusion 331 and the second protrusion 332 may be integrally formed with the partition wall unit 310.

However, the embodiment is not limited thereto, and the protrusion part may include a material different from that of the partition wall unit 310, and the protrusion part and the partition wall unit 310 may be formed separately from each other.

At least one of the first protrusion 331 and the second protrusion 332 may be formed in the receiving unit 320. In detail, one or a plurality of the first protrusion 331 and the second protrusion 332 may be disposed inside the receiving unit.

When the light route control member is used by the first protrusion 331 and the second protrusion 332, it is possible to inhibit the light absorbing particles inside the receiving unit from moving in the downward direction and being aggregated in one area. Accordingly, it is possible to inhibit the light absorbing particles from being agglomerated in one region and the dispersibility of the light absorbing particles from being reduced, so that the viewing angle control characteristic of the light route control member can be maintained even when the light route controlling member is driven for a long time.

In addition, by the first protrusion 331 and the second protrusion 332, it is possible to control the viewing angles in the left-right direction and the up-down direction, that is, the light route control member can control the viewing angles in four directions.

That is, by the first protrusion 331 and the second protrusion 332, the receiving unit 320 may also include a receiving unit extending in one direction and a receiving unit extending in another direction different from the one direction. That is, since the extension direction of the receiving unit is also extended in two directions by the first protrusion 331 and the second protrusion 332, viewing angles in four directions in the left-right direction and the up-down direction can be controlled according to each extending direction.

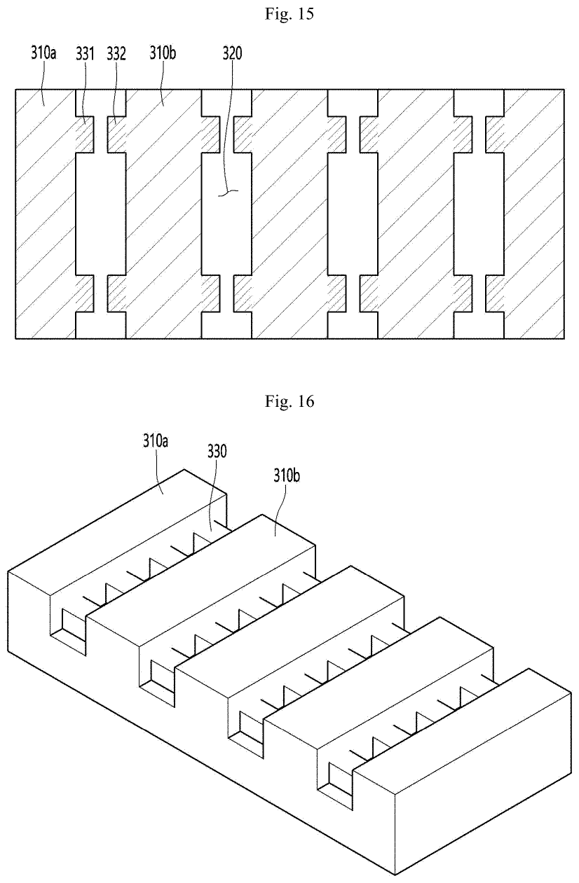

Referring to FIGS. 14 and 15, a plurality of protrusions may be disposed inside the receiving unit 320. In detail, a plurality of protrusions connected to the partition wall unit 310 may be disposed inside the receiving unit 320.

The protrusion 330 may include a first protrusion 331 and a second protrusion 332. In detail, the protrusion 330 includes a first protrusion 331 extending from the first partition wall unit 310a to the second partition wall unit 310b adjacent to the first partition wall unit 310a, and a second protrusion 332 extending from the second partition wall unit 310b to the first partition wall unit 310a adjacent to the second partition wall unit 310b.

That is, the first protrusion 331 and the second protrusion 332 may be disposed inside the same receiving unit.

In detail, the first protrusion 331 and the second protrusion 332 may extend in a direction in which the partition wall unit 310 extends, that is, in a direction different from the longitudinal direction. For example, the first protrusion 331 and the second protrusion 332 may extend in a direction perpendicular to the direction in which the partition wall unit 310 extends, but the embodiment is not limited thereto.

The first protrusion 331 and the second protrusion 332 may be disposed at the same height as the partition wall unit 310. In addition, the first protrusion 331 and the second protrusion 332 may be disposed to have a length smaller than the width of the receiving unit 320. That is, in order to inhibit the receiving unit 320 from being closed by the first protrusion 331 and the second protrusion 332, the first protrusion 331 and the second protrusion 332 has a length smaller than the width of the receiving unit 320.

The first protrusion 331 may be in contact with the first partition wall unit 310a and may be disposed to be spaced apart from the second partition wall unit 310b. In addition, the second protrusion 332 may be in contact with the second partition wall unit 310b and may be disposed to be spaced apart from the third partition wall unit 310c.

The first protrusion 331 and the second protrusion 332 may be disposed at positions that overlap each other within the receiving units 320. For example, the first protrusion 331 overlaps the second protrusion 332 in a direction in which the first protrusion 331 extends, and the second protrusion 332 overlaps the first protrusion 331 in a direction in which the second protrusion 332 extends.

That is, the first protrusion 331 and the second protrusion 332 may be disposed to face each other in the receiving unit 320. In addition, the first protrusion 331 and the second protrusion 332 are disposed to face each other inside the receiving unit 320, and the first protrusion 331 and the second protrusion 332 may be disposed to be spaced apart from each other in the receiving unit 320.

The first protrusion 331 and the second protrusion 332 may include the same material as the partition wall unit 310. That is, the first protrusion 331 and the second protrusion 332 may include a light-transmitting material. Also, the first protrusion 331 and the second protrusion 332 may be integrally formed with the partition wall unit 310.

However, the embodiment is not limited thereto, and the protrusion part may include a material different from that of the partition wall unit 310, and the protrusion part and the partition wall unit 310 may be formed separately from each other.

At least one of the first protrusion 331 and the second protrusion 332 may be formed in the receiving unit 320. In detail, one or a plurality of the first protrusion 331 and the second protrusion 332 may be disposed inside the receiving unit.

When the light route control member is used by the first protrusion 331 and the second protrusion 332, it is possible to inhibit the light absorbing particles inside the receiving unit from moving in the downward direction and being aggregated in one area. Accordingly, it is possible to inhibit the light absorbing particles from being agglomerated in one region and the dispersibility of the light absorbing particles from being reduced, so that the viewing angle control characteristic of the light route control member can be maintained even when the light route controlling member is driven for a long time.

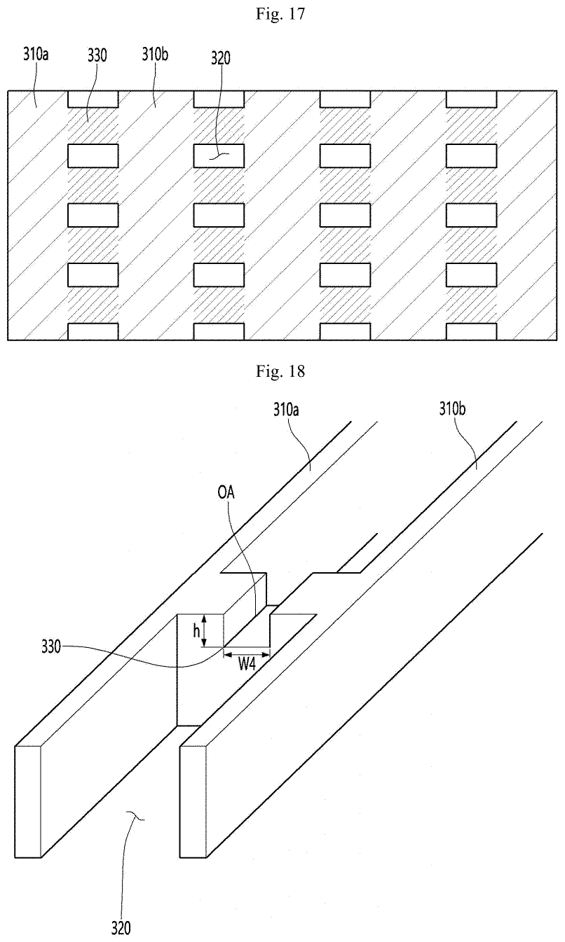

Referring to FIGS. 16 and 17, a plurality of protrusions may be disposed inside the receiving unit 320. In detail, a plurality of protrusions connected to the partition wall unit 310 may be disposed inside the receiving unit 320.

The protrusion 330 may be disposed at the different height as the partition wall unit 310. In detail, the height of the protrusion 330 may be smaller than the height of the partition wall unit. In addition, the length of the protrusion 330 may be the same as the width of the receiving unit 320. That is, the height of the protrusion 330 may be smaller than the height of the partition wall unit 310 so that the receiving unit 320 is not closed by the protrusion 330.

The protrusion part 330 may be formed to extend from the first partition wall unit 310a in the direction of the second partition wall unit 310b adjacent to the first partition wall unit 310a. The protrusion 330 may be disposed in contact with both the first partition wall unit 310a and the second partition wall unit 310b.

In detail, the protrusion 330 may extend in a direction in which the partition wall unit 310 extends, that is, in a direction different from the longitudinal direction. For example, the protrusion 330 may extend in a direction perpendicular to the direction in which the partition wall unit 310 extends, but the embodiment is not limited thereto.

The protrusion 330 may include the same material as the partition wall unit 310. That is, the protrusion 330 may include a light-transmitting material. Also, the protrusion 330 may be integrally formed with the partition wall unit 310.

However, the embodiment is not limited thereto, and the protrusion part may include a material different from that of the partition wall unit 310, and the protrusion part and the partition wall unit 310 may be formed separately from each other.

At least one of the protrusions 330 may be formed in the receiving unit 320. In detail, one or a plurality of the protrusion 330 may be disposed inside the receiving unit.

When the light route control member is used by the protrusion 330, it is possible to inhibit the light absorbing particles inside the receiving unit from moving in the downward direction and being aggregated in one area. Accordingly, it is possible to inhibit the light absorbing particles from being agglomerated in one region and the dispersibility of the light absorbing particles from being reduced, so that the viewing angle control characteristic of the light route control member can be maintained even when the light route controlling member is driven for a long time.

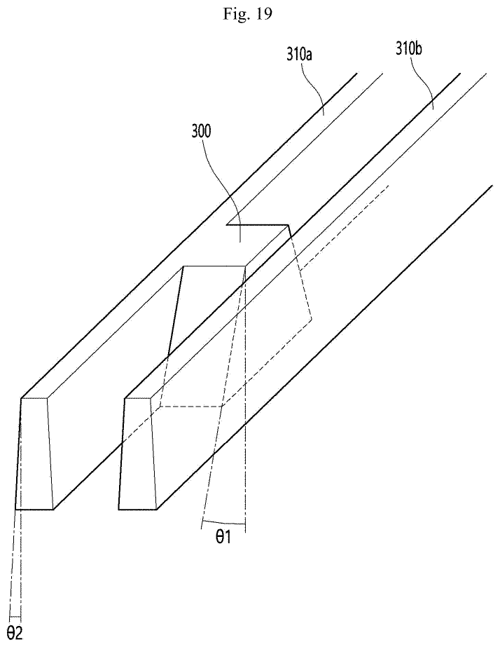

FIGS. 18 and 19 are diagrams illustrating perspective views of one region of the receiving unit and the partition wall unit.

Referring to FIG. 18, the protrusions 330 may be disposed inside the receiving unit 320. In detail, at least one protrusion 330 connected to the partition wall unit 310 may be disposed inside the receiving unit 320.

The protrusion 330 may be disposed at the same height as the partition wall unit 310. In addition, the length of the protrusion 330 may be the same as the width of the receiving unit 320. Also, the protrusion 330 may include an opening area OA. In detail, the height h of the opening region may be 50% or less of the height of the protrusion, and the width w4 of the opening region may have a size of 10% to 50% of the width of the receiving unit.

That is, the opening area OA may be formed in the protrusion 330 so that the receiving unit 320 is not closed by the protrusion 330.

The protrusion part 330 may be formed to extend from the first partition wall unit 310a in the direction of the second partition wall unit 310b adjacent to the first partition wall unit 310a. The protrusion 330 may be disposed in contact with both the first partition wall unit 310a and the second partition wall unit 310b.

In detail, the protrusion 330 may extend in a direction in which the partition wall unit 310 extends, that is, in a direction different from the longitudinal direction. For example, the protrusion 330 may extend in a direction perpendicular to the direction in which the partition wall unit 310 extends, but the embodiment is not limited thereto.

The protrusion 330 may include the same material as the partition wall unit 310. That is, the protrusion 330 may include a light-transmitting material. Also, the protrusion 330 may be integrally formed with the partition wall unit 310.

However, the embodiment is not limited thereto, and the protrusion part may include a material different from that of the partition wall unit 310, and the protrusion part and the partition wall unit 310 may be formed separately from each other.

At least one of the protrusions 330 may be formed in the receiving unit 320. In detail, one or a plurality of the protrusion 330 may be disposed inside the receiving unit.

When the light route control member is used by the protrusion 330, it is possible to inhibit the light absorbing particles inside the receiving unit from moving in the downward direction and being aggregated in one area. Accordingly, it is possible to inhibit the light absorbing particles from being agglomerated in one region and the dispersibility of the light absorbing particles from being reduced, so that the viewing angle control characteristic of the light route control member can be maintained even when the light route controlling member is driven for a long time.

Referring to FIG. 19, the protrusions 330 may be disposed inside the receiving unit 320. In detail, at least one protrusion 330 connected to the partition wall unit 310 may be disposed inside the receiving unit 320.

The protrusion 330 may be disposed at the same height as the partition wall unit 310. In addition, the length of the protrusion 330 may be smaller than the width of the receiving unit 320.

That is, the length of the protrusion 330 may be smaller than the width of the receiving unit 320 so that the region of the receiving unit 320 is not closed by the protrusion 330.

The protrusion part 330 may be formed to extend from the first partition wall unit 310a in the direction of the second partition wall unit 310b adjacent to the first partition wall unit 310a. In detail, the protrusion 330 may extend in a direction in which the partition wall unit 310 extends, that is, in a direction different from the longitudinal direction. For example, the protrusion 330 may extend in a direction perpendicular to the direction in which the partition wall unit 310 extends, but the embodiment is not limited thereto.

The protrusion part 330 may be in contact with the first partition wall unit 310a and may be disposed to be spaced apart from the second partition wall unit 310b. That is, the protrusion unit 330 may be disposed to be spaced apart from the second partition wall unit 310b by a predetermined distance.

The partition wall unit 310 and the protrusion 330 may include inclined surfaces.

In detail, the partition wall unit 310 includes a side surface including a surface in contact with the protrusion 330 and a surface opposite thereto. A side surface of the partition wall unit 310 may be inclined at a first angle θ1.

In addition, the protrusion 330 is a surface in contact with the first partition wall unit 310, and a side surface defined as a surface connecting the surfaces of the protrusion 330 and the second partition wall unit 310b facing each other. The side surface of the protrusion 330 may be inclined at a second angle θ2.

In this case, the first angle θ1 and the second angle θ2 may be different from each other. In detail, the second angle θ2 may be greater than the first angle θ1. For example, the second angle θ2 may be 5 times or less greater than the first angle θ1.

When the second angle θ2 is smaller than the first angle θ1, the shape of the receiving unit to be implemented may be changed due to a mold release defect during the mold imprinting process for forming the receiving unit. And when the second angle θ2 exceeds 5 times the first angle θ1, the protrusion area becomes too large by the inclined surface, so that the area in which the dispersion and the light-absorbing particle dispersed in the receiving unit are disposed is reduced. Accordingly, the dispersibility of the light absorbing particles may be reduced.

The protrusion 330 may include the same material as the first partition wall unit 310a. That is, the protrusion 330 may include a light-transmitting material. Also, the protrusion 330 may be integrally formed with the first partition wall unit 310a.

However, the embodiment is not limited thereto, and the protrusion part may include a material different from that of the partition wall unit 310, and the protrusion part and the partition wall unit 310 may be formed separately from each other.

When the light route control member is used by the protrusion 330, it is possible to inhibit the light absorbing particles inside the receiving unit from moving in the downward direction and being aggregated in one area. Accordingly, it is possible to inhibit the light absorbing particles from being agglomerated in one region and the dispersibility of the light absorbing particles from being reduced, so that the viewing angle control characteristic of the light route control member can be maintained even when the light route controlling member is driven for a long time.

Meanwhile, the receiving unit 320 may be formed in various shapes.

Referring to FIGS. 4 and 5, the receiving unit 320 extends from one end of the receiving unit 320 to the other end, and the width of the receiving unit 320 may be changed.

For example, referring to FIGS. 4 and 5, the receiving unit 320 may be formed in a trapezoidal shape. In detail, the receiving unit 320 may extend from the first electrode 210 to the second electrode 220 and may be formed to widen the width of the receiving unit 320.

That is, the width of the receiving unit 320 may be narrowed while extending in the opposite direction from the user's viewing surface. Also, when a voltage is applied to the light conversion unit, the light absorbing particles of the receiving unit 320 may move in a direction in which the width of the receiving unit is narrowed.

That is, the width of the receiving unit 320 may be increased while extending from the light incident part to which the light is incident to the light output part from which the light is emitted.

Accordingly, since the light absorbing particles move in a direction opposite to the viewing surface rather than the viewing surface, blocking of light emitted in the viewing surface direction can be inhibited, thereby improving the luminance of the light route control member.

In addition, since the light absorbing particles move from a wide region to a narrow region, the light absorbing particles may be easily moved.

In addition, since the light absorbing particles move to a narrow area of the receiving unit, the amount of light transmitted in the direction of the user's viewing surface may be increased, thereby improving front luminance.

Alternatively, on the contrary, the receiving unit 320 may be formed so that the width of the receiving unit 320 is narrowed while extending from the first electrode 210 to the second electrode 220.

That is, the width of the receiving unit 320 may be widened while extending from the user's viewing surface to the opposite surface direction. Also, when a voltage is applied to the light conversion unit, the light absorbing particles of the receiving unit 320 may move in a direction in which the width of the receiving unit is widened.

That is, the width of the receiving unit 320 may be narrowed while extending from the light incident part to which the light is incident to the light output part from which the light is emitted.

Accordingly, the contact area between the first electrode and one surface of the receiving unit through which the light absorbing particles move is increased, so that the moving speed of the light absorbing particles, that is, the driving speed can be increased.

Meanwhile, the receiving unit 320 may be disposed to be spaced apart from the first electrode 210 or the second electrode 220.

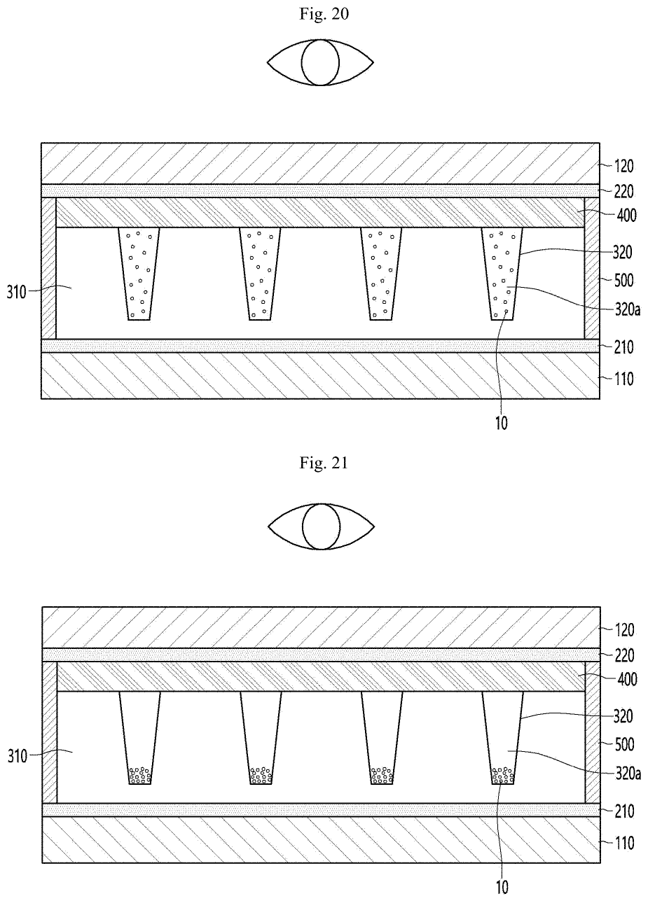

For example, referring to FIGS. 20 and 21, the receiving unit 320 may be spaced apart from the first electrode 210 and may be in direct or indirect contact with the second electrode 220.

The same or similar material to the partition wall unit 310 may be disposed in a region where the receiving unit 320 and the first electrode 210 are spaced apart from each other.

Accordingly, by increasing the transmittance of the light emitted in the direction of the viewing plane, the luminance of the light route control member may be improved, thereby improving visibility.

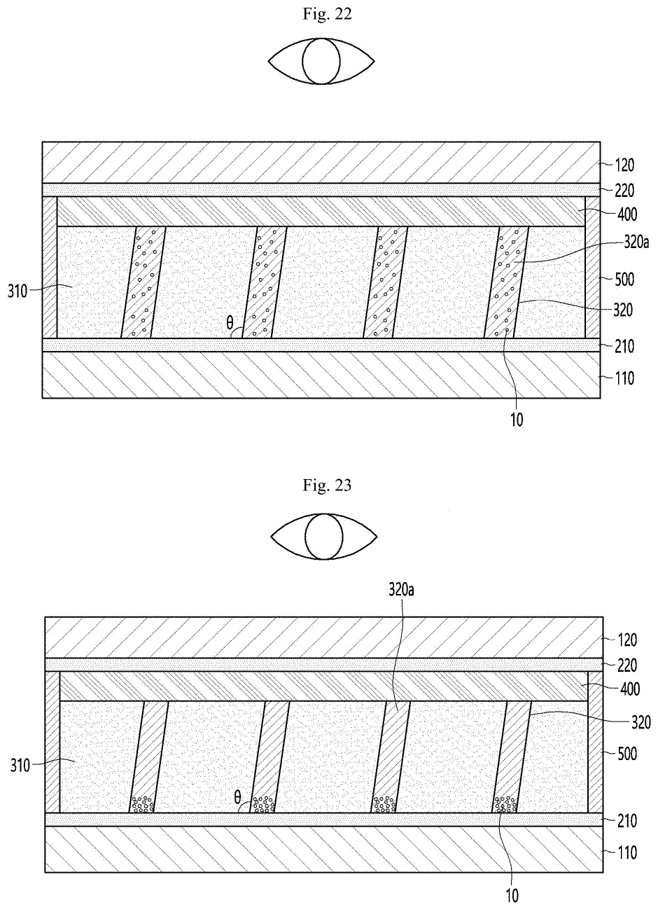

In addition, the receiving unit 320 may be disposed while having a constant inclination angle θ. In detail, referring to FIGS. 22 and 23, the receiving unit 320 may be disposed with an inclination angle θ of greater than 0° to less than 90° with respect to the first electrode 210. In detail, the receiving unit 320 may extend upwardly while having an inclination angle θ of greater than 0° to less than 90° with respect to one surface of the first electrode 210.

Accordingly, when the light route control member is used together with the display panel, moire caused by the overlapping between the pattern of the display panel and the receiving unit 320 of the light route control member may be inhibited, thereby improving user visibility.

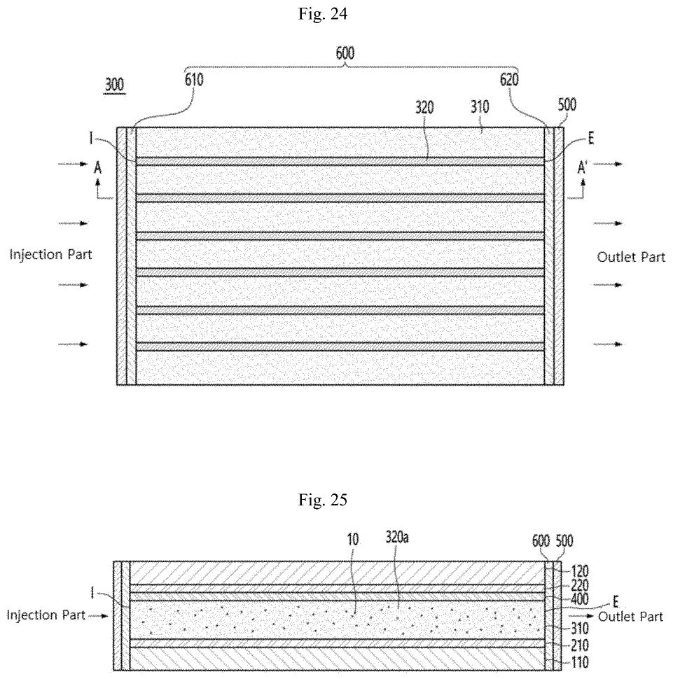

Hereinafter, an light route control member according to another embodiment will be described with reference to FIGS. 24 and 25.

Referring to FIGS. 24 and 25, the dispersion 320a in which the light absorbing particles 10 described above are dispersed may be disposed in the receiving unit 320 of the light converting unit 300. The dispersion 320a may be injected from one direction of the light conversion unit 300. In detail, the light conversion unit 300 has an injection part I and an outlet part E opposite to the injection part, and the dispersion may be injected from the injection part toward the outlet part.

A filter layer 600 may be disposed on the injection part and the outlet part of the light conversion unit 300. In addition, a sealing layer 500 may be disposed on the outer surface of the filter layer 600.

The filter layer 600 may be disposed in direct contact with the light conversion unit 300. That is, the filter layer 600 may include a first filter layer 610 disposed in contact with one end of the injection part of the light conversion unit and a second filter layer 620 disposed in contact with the other end of the outlet part of the light conversion unit.

That is, the filter layer 600 may be in contact with one end of the receiving unit and the other end of the receiving unit. That is, the filter layer 600 may be disposed in direct contact with one end of the receiving unit defined as the injection part and the other end of the receiving unit defined as the outlet part.

The filter layer 600 may include pores. In detail, the filter layer 600 may be a porous layer including a plurality of pores.

The material moving in the direction of the filter layer 600 may be selectively filtered by a phase of the material. In detail, liquid and solid substances may not pass through the filter layer 600, and gaseous substances may pass through the filter layer 600. That is, the filter layer 600 is formed of a porous layer including a plurality of pores, liquid and solid substances are blocked by the porous layer, and gaseous substances can be transmitted.

The filter layer 600 may be formed to a thickness of about 0.5 mm or less. In detail, the thickness of the filter layer 600 may be 0.15 mm to 0.5 mm. When the thickness of the filter layer 600 is less than 0.15 mm, it is difficult to effectively filter the material passing through the filter layer 600 by the filter layer 600, In addition, when the thickness of the filter layer 600 exceeds 0.5 mm, there is a problem in that the bezel area is increased by the filter layer.

The filter layer 600 may include a resin material. That is, the filter layer 600 may include a resin material having a porous layer. For example, the filter layer 600 may include at least one of (e) PTFE ((Expanded) Polytetrafluoroethylene), PET (Polyethylene terephthalate), and nylon.

That is, in the case of the dispersion that is injected from the injection part toward the outlet part, the dispersion material does not pass by the filter layer disposed at the other end of the light conversion unit, and air that can be injected together with the dispersion may pass.

Accordingly, when injecting the dispersion into the receiving unit 320, the air that can be injected together with the dispersion by the filter layer 600 is discharged to the outside, and the dispersion may be filled up to the other end of the receiving unit. Accordingly, it is possible to remove the air layer that inhibits the filling properties of the dispersion in the receiving unit 320, it is possible to improve the filling properties of the dispersion.

In addition, when disposing the sealing layer 500 after injecting the dispersion, contact between the sealing layer 500 and the dispersion 320a may be inhibited. That is, the sealing layer and the dispersion 320a come into contact with each other before the sealing layer formed by curing the viscous material is cured, thereby inhibiting the sealing layer from penetrating into the dispersion. In detail, the filter layer 600 is disposed between the dispersion 320a and the sealing layer 500. In addition, the filter layer 600 selectively filters the material by the phase of the material. Accordingly, contact between the dispersion 320a and the sealing layer 500 may be inhibited.

Meanwhile, as will be described in detail below, the first filter layer 610 and the second filter layer 620 may be sequentially disposed. In detail, the second filter layer 620 may be disposed, and the first filter layer 610 may be disposed after the dispersion 320a is completely filled in the receiving unit.

Accordingly, when the dispersion is filled by the second filter layer 620, a passage for discharging air to the outside is formed so that the dispersion can be stably filled. In addition, after filling all of the dispersion by the first and second filter layers, the dispersion may be sealed inside the receiving unit.

The light route control member according to another embodiment may have improved driving characteristics and an effect of controlling the viewing angle. In detail, by improving the filling properties of the dispersion filled inside the receiving unit that changes the movement of the light, the dispersion can be stably disposed inside the receiving unit.

Accordingly, it is possible to inhibit the formation of an air layer inside the receiving unit, thereby inhibiting unintentional refraction of light or transmission of light by the air layer.

Accordingly, the light route control member according to another embodiment may have improved characteristics.

The light route control member according to another embodiment may have improved driving characteristics and an effect of controlling the viewing angle. In detail, by improving the filling properties of the dispersion filled inside the receiving unit that changes the movement of the light, the dispersion can be stably disposed inside the receiving unit.

Accordingly, it is possible to inhibit the formation of an air layer inside the receiving unit, thereby inhibiting unintentional refraction of light or transmission of light by the air layer.

Accordingly, the light route control member according to another embodiment may have improved characteristics.

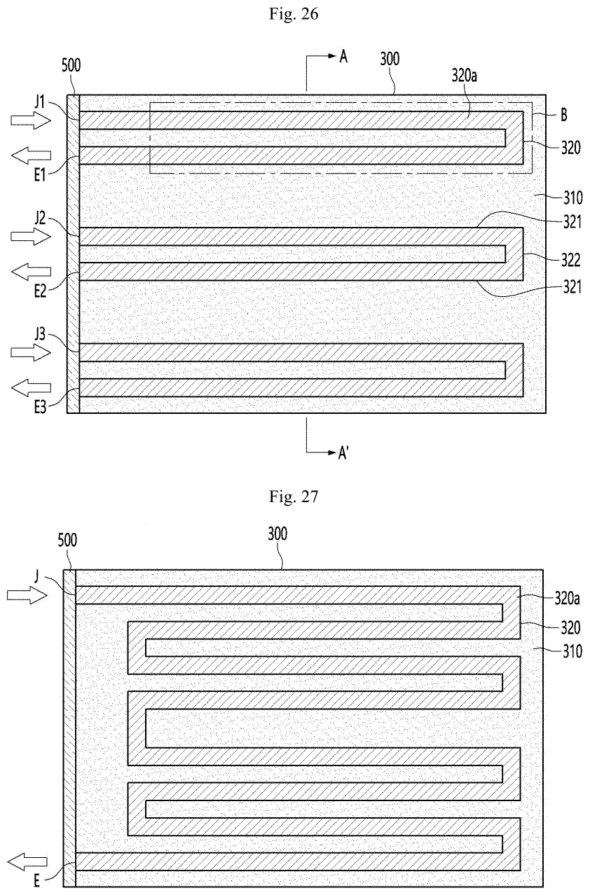

Hereinafter, a light route control member according to another embodiment will be described with reference to FIGS. 26 and 34.

Meanwhile, referring to FIGS. 26 and 27, the receiving unit 320 may include an injection part J and an outlet part E. The injection part J may be defined as a region where injection of the dispersion is started, and the outlet part E may be defined as a region where injection of the dispersion is terminated.

At least one of the injection part J and the outlet part E may be formed. In detail, referring to FIG. 26, the injection part J may include a first injection part J1, a second injection part J2, and a third injection part J3. In addition, the outlet part E includes a first outlet part E1 connected to the first injection part J1, a second outlet part E2 connected to the second injection part J2, and the third outlet part E3 connected to the third injection part J3.

Alternatively, referring to FIG. 27, the receiving unit 320 may include only one injection part J and one outlet part E.

The injection part J and the outlet part E may be disposed on the same surface of the receiving unit 320. For example, the receiving unit 320 may include a first surface 1S, a second surface 2S opposite to the first surface 1S, a third surface (3S) connecting the first surface 1S and the second surface 2S, and a fourth surface 4S opposite to the third surface 3S.

The first surface 1S, the second surface 2S, the third surface 3S, and the fourth surface 4S may be defined as side surfaces of the receiving unit 320. In addition, the first surface 1S, the second surface 2S, the third surface 3S, and the fourth surface 4S may be connected to each other.

The injection part J and the outlet part E may be disposed on any one of the first surface 1S, the second surface 2S, the third surface 3S, and the fourth surface 4S. For example, referring to FIGS. 26 and 27, the injection part J and the outlet part E may be disposed on the first surface 1S. That is, the injection part J and the outlet part E may be disposed on the same surface of the receiving unit 320.

Accordingly, the dispersion exposed by the injection part J and the outlet part E can be sealed only on one surface of the receiving unit 320.

Conventionally, the injection part is disposed on one surface of the receiving unit, and the outlet part is disposed on the other surface opposite to the one surface. That is, the injection part and the outlet part were respectively disposed on two surfaces of the receiving unit. Accordingly, sealing layers for sealing the injection part and the outlet part were also disposed on two surfaces of the receiving unit.

Accordingly, there is a problem in that the bezel area of the light route control member is widened.

Accordingly, in the light route control member according to the embodiment, the injection part J and the outlet part E are disposed on one surface of the receiving unit. Then, after all the dispersion is injected into the receiving unit, a sealing layer is formed on only one surface of the receiving unit. Thereby, the bezel area can be reduced.

On the other hand, the injection part J and the outlet part E may include an inclined surface. For example, the injection part J and the outlet part E may have inclined surfaces in different directions. Accordingly, the injection part J and the outlet part E may be formed to have different heights. In detail, the injection part J may have an inclined surface extending downwardly while extending from the starting point of the injection part (J) in the direction of the receiving unit 320. Also, the outlet part E may have an inclined surface extending downwardly while extending from the receiving unit 320 to the outlet part E.

Accordingly, since the dispersion moving into the receiving unit through the injection part J and the outlet part E moves from the top to the bottom, the dispersion can be easily filled in the receiving unit.

In addition, the receiving unit may include a first receiving unit 321 disposed to extend in a first direction and a second receiving unit 322 disposed to extend in a second direction different from the first direction. For example, the first direction and the second direction may be perpendicular to each other.

By disposing the receiving unit in the first and second directions, that is, in the horizontal direction and the vertical direction, the viewing angle of the light route control member may be controllable in four directions. That is, the viewing angle in the left-right direction can be controlled by the receiving unit extending in the first direction, and the viewing angle in the up-down direction can be controlled by the receiving unit extending in the second direction. Accordingly, the viewing angle of the light route control member can be controlled in four directions without further forming a separate light conversion unit.

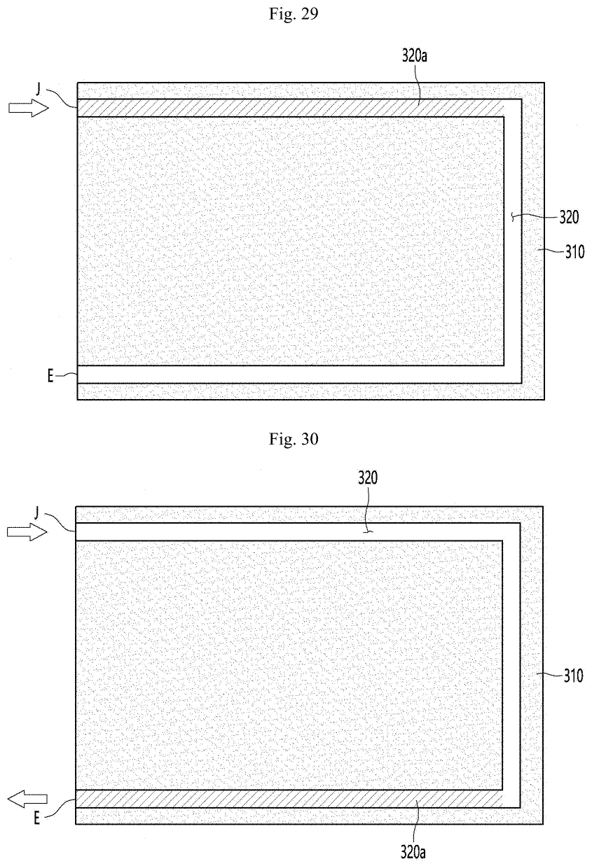

FIGS. 29 to 34 are views for explaining a process of injecting a dispersion into the receiving unit in the light route control member according to the embodiment.

First, referring to FIG. 29, the dispersion 320a is injected into the receiving unit 320 through the injection part J.

Then, referring to FIG. 30, the dispersion may be sucked in a vacuum suction method using a suction device at the outlet part E. Accordingly, the dispersion 320a injected from the injection part J may be moved in the direction of the outlet part E. In this case, the suction device may inhibit impurities such as bubbles from being generated in the dispersion by sucking the air injected together with the dispersion while at the same time sucking the dispersion.

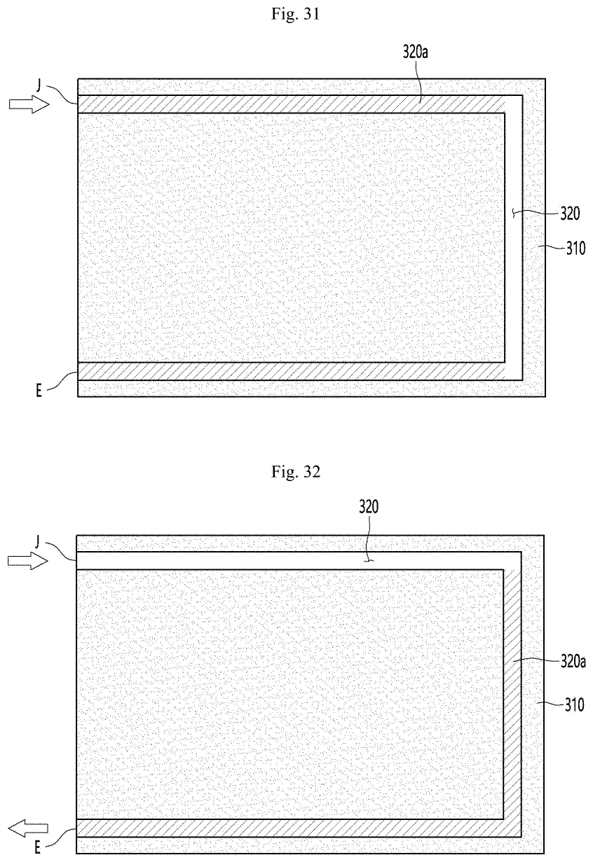

Subsequently, referring to FIGS. 31 and 32, the dispersion 320a may be re-injected into the receiving unit 320 through the injection part J.

Subsequently, the dispersion may be sucked in a vacuum suction method using a suction device at the outlet part E. Accordingly, the dispersion 320a injected from the injection part J may be moved in the direction of the outlet part E.

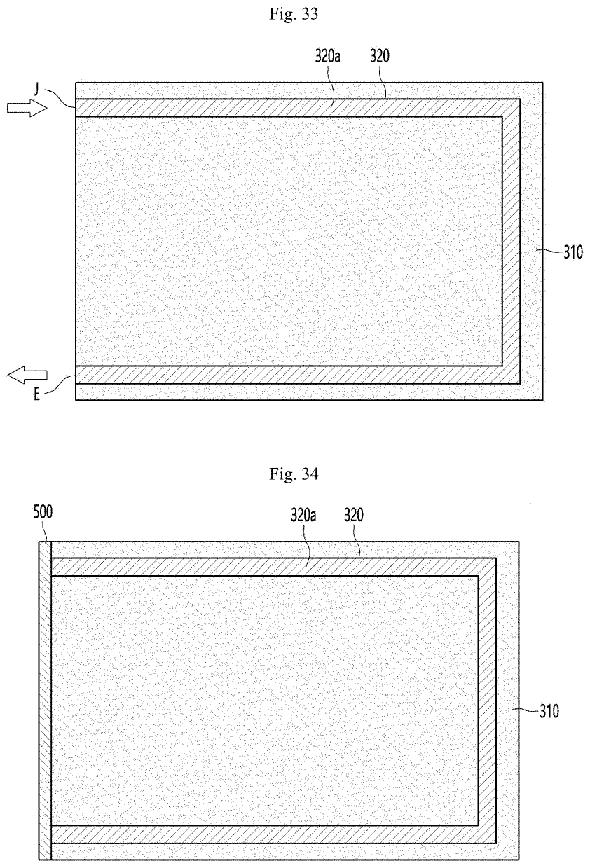

Then, referring to FIG. 33, the dispersion 320a is injected again into the receiving unit 320 through the injection part J, and all of the dispersion 320a may be filled in the receiving unit 320.

Then, referring to FIG. 34, the dispersion 320a may be sealed by disposing a sealing layer 500 on one surface of the receiving unit where the injection part J and the outlet part E are disposed.

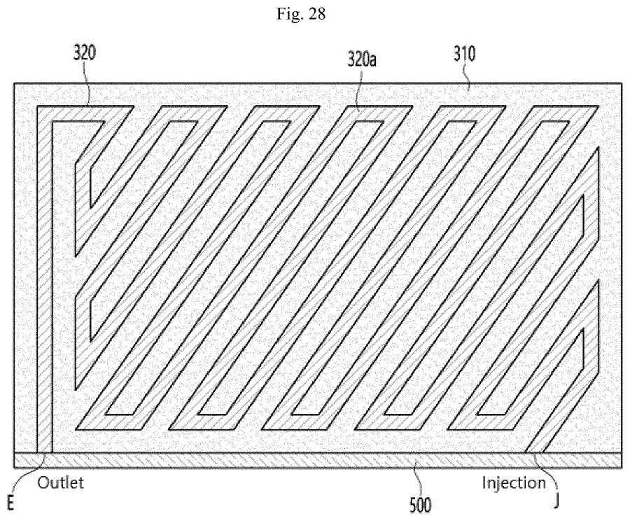

Meanwhile, referring to FIG. 28, the receiving unit may be formed in an oblique direction. In detail, the receiving unit 320 may be formed while having an inclination with respect to the longitudinal direction of the light converting unit 300. For example, the receiving unit 320 may extend at an angle of about 5° to about 20° with respect to the longitudinal direction of the light conversion unit 300. Accordingly, when the light route member is used together with the display panel, moire caused by overlapping of the pattern of the display panel and the receiving unit 320 of the light route member may be inhibited, thereby improving user visibility.

In FIG. 28, the injection part J and the outlet part E disposed in the receiving unit may be disposed on one surface of the receiving unit 320.

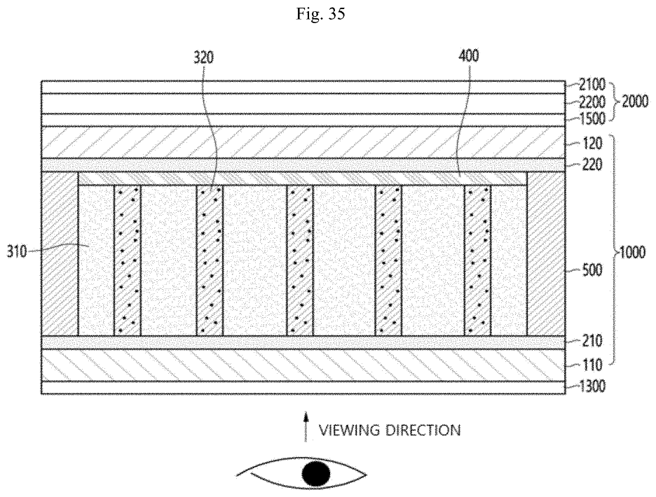

Hereinafter, referring to FIGS. 35 to 37, a display device and a display apparatus to which a light route control member according to an embodiment is applied will be described.

Referring to FIG. 35, a light route control member 1000 according to an embodiment may be disposed on a display panel 2000.

The display panel 2000 and the light route control member 1000 may be disposed to be adhered to each other. For example, the display panel 2000 and the light route control member 1000 may be adhered to each other via an adhesive layer 1500. The adhesive layer 1500 may be transparent. For example, the adhesive layer 1500 may include an adhesive or an adhesive layer containing an optical transparent adhesive material.

The adhesive layer 1500 may include a release film. In detail, when adhering the light route control member and the display panel, the light route control member and the display panel may be adhered after the release film is removed.

The display panel 2000 may include a first substrate 2100 and a second substrate 2200. When the display panel 2000 is a liquid crystal display panel, the light route control member may be formed under the liquid crystal panel. That is, when the user-viewed side of the liquid crystal panel is defined as the upper portion of the liquid crystal panel, the light route control member may be disposed below the liquid crystal panel. The display panel 2000 may be formed in a structure in which the first substrate 2100 including a thin film transistor (TFT) and a pixel electrode and the second substrate 2200 including color filter layers are bonded with a liquid crystal layer interposed therebetween.

In addition, the display panel 2000 may be a liquid crystal display panel of a color filter on transistor (COT) structure in which a thin film transistor, a color filter, and a black matrix are formed at the first substrate 2100 and the second substrate 2200 is bonded to the first substrate 2100 with the liquid crystal layer interposed therebetween. That is, a thin film transistor may be formed on the first substrate 2100, a protective film may be formed on the thin film transistor, and a color filter layer may be formed on the protective film. In addition, a pixel electrode in contact with the thin film transistor may be formed on the first substrate 2100. At this point, in order to improve an aperture ratio and simplify a masking process, the black matrix may be omitted, and a common electrode may be formed to function as the black matrix.

In addition, when the display panel 2000 is the liquid crystal display panel, the display device may further include a backlight unit providing light from a rear surface of the display panel 2000. The backlight unit may be disposed under the light route control member.

That is, as shown in FIG. 35, the light route control member may be disposed under the liquid crystal panel.

Alternatively, when the display panel 2000 is an organic light emitting display panel, the light route control member may be formed on the organic light emitting display panel. That is, when the surface viewed by the user of the organic light emitting display panel is defined as the upper portion of the organic light emitting display panel, the light route control member may be disposed on the organic light emitting display panel. The display panel 2000 may include a self-luminous element that does not require a separate light source. In the display panel 2000, a thin film transistor may be formed on the first substrate 2100, and an organic light emitting element in contact with the thin film transistor may be formed. The organic light emitting element may include an anode, a cathode, and an organic light emitting layer formed between the anode and the cathode. Further, the second substrate 2200 configured to function as an encapsulation substrate for encapsulation may further be included on the organic light emitting element.

Furthermore, although not shown in drawings, a polarizing plate may be further disposed between the light route control member 1000 and the display panel 2000. The polarizing plate may be a linear polarizing plate or an external light reflection preventive polarizing plate. For example, when the display panel 2000 is a liquid crystal display panel, the polarizing plate may be the linear polarizing plate. Further, when the display panel 2000 is the organic light emitting display panel, the polarizing plate may be the external light reflection preventive polarizing plate.

In addition, an additional functional layer 1300 such as an anti-reflection layer, an anti-glare, or the like may be further disposed on the light route control member 1000. Specifically, the functional layer 1300 may be adhered to one surface of the substrate of the light route control member. Although not shown in drawings, the functional layer 1300 may be adhered to the base 100 of the light route control member via an adhesive layer. In addition, a release film for protecting the functional layer may be further disposed on the functional layer 1300.

Further, a touch panel may be further disposed between the display panel and the light route control member.

Although it is shown in the drawings that the light route control member is disposed at an upper portion of the display panel, but the embodiment is not limited thereto, and the light route control member may be disposed at various positions such as a position in which light is adjustable, that is, a lower portion of the display panel, between a second substrate and a first substrate of the display panel, or the like.

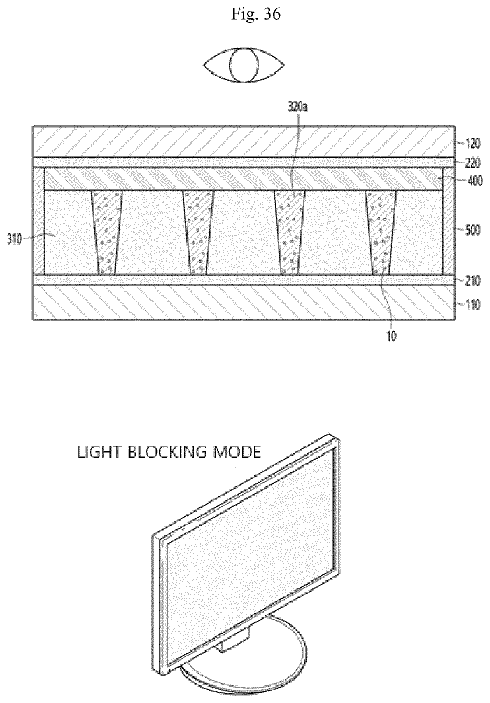

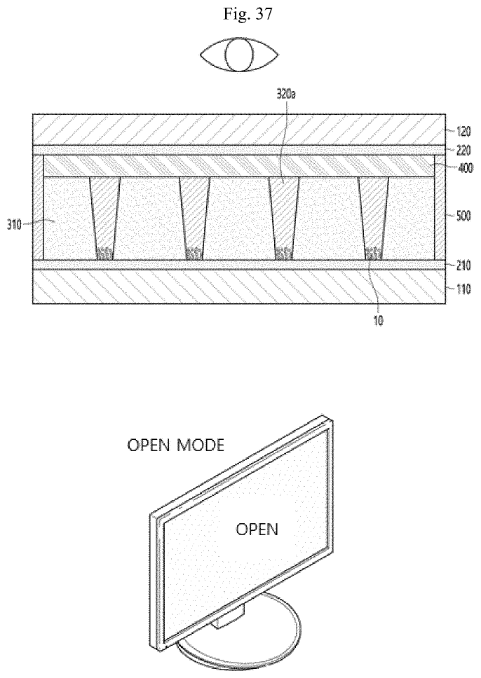

Referring to FIGS. 36 and 37, the light route control member according to the embodiment may be applied to a vehicle.

Referring to FIGS. 36 and 37, the light route control member according to the embodiment may be applied to a display device that displays a display.

For example, when power is not applied to the light route control member as shown in FIG. 36, the receiving unit functions as the light blocking part, so that the display device is driven in a light blocking mode, and when power is applied to the light route control member as shown in FIG. 37, the receiving unit functions as the light transmitting part, so that the display device may be driven in an open mode.

Accordingly, a user may easily drive the display device in a privacy mode or a normal mode according to application of power.

In addition, although not shown in the drawings, the display device to which the light route control member according to the embodiment is applied may also be applied inside the vehicle.

For example, the display device including the light route control member according to the embodiment may display a video confirming information of the vehicle and a movement route of the vehicle. The display device may be disposed between a driver seat and a passenger seat of the vehicle.

In addition, the light route control member according to the embodiment may be applied to a dashboard that displays a speed, an engine, an alarm signal, and the like of the vehicle.

Furthermore, the light route control member according to the embodiment may be applied to a front glass (FG) of the vehicle or right and left window glasses.

The characteristics, structures, effects, and the like described in the above-described embodiments are included in at least one embodiment of the present invention, but are not limited to only one embodiment. Furthermore, the characteristic, structure, and effect illustrated in each embodiment may be combined or modified for other embodiments by a person skilled in the art. Accordingly, it is to be understood that such combination and modification are included in the scope of the present invention.

In addition, embodiments are mostly described above, but the embodiments are merely examples and do not limit the present invention, and a person skilled in the art may appreciate that several variations and applications not presented above may be made without departing from the essential characteristic of embodiments. For example, each component specifically represented in the embodiments may be varied. In addition, it should be construed that differences related to such a variation and such an application are included in the scope of the present invention defined in the following claims.

1. A light route control member comprising:
a first substrate;
a first electrode disposed on an upper surface of the first substrate;
a second substrate disposed on the first substrate;
a second electrode disposed on a lower surface of the second substrate; and
a light conversion unit disposed between the first electrode and the second electrode,
wherein the light conversion unit includes a partition wall unit and a receiving unit that are alternately disposed,
wherein the receiving unit includes a dispersion and a plurality of light absorbing particles dispersed in the dispersion,
wherein at least one protrusion is disposed inside the receiving unit,
wherein the protrusion is disposed to extend in a direction different from a direction in which the partition wall unit extends.

2. The light route control member of claim 1, wherein the partition wall unit includes a first partition wall unit and a second partition wall unit adjacent to the first partition wall unit,
wherein the protrusion extends from the first partition wall unit toward the second partition wall unit.

3. The light route control member of claim 1, wherein a length of the protrusion is smaller than a width of the receiving unit.

4. The light route control member of claim 2, wherein a distance between the protrusion and the second partition wall unit is 10% to 50% of the width of the receiving unit.

5. The light route control member of claim 1, wherein the protrusion and the partition wall unit are integrally formed.

6. The light route control member of claim 1, wherein a width of the protrusion is equal to or greater a width of the receiving unit and less than or equal to a sum of the width of the receiving unit and a width of the partition wall unit.

7. The light route control member of claim 1, wherein the protrusion includes a plurality of protrusions,
wherein a distance between the protrusions is 1 to 20 times a width of the receiving unit.

8. The light route control member of claim 2, wherein the protrusion includes a first protrusion in contact with the first partition wall unit; and a second protrusion in contact with the second partition wall unit,
wherein the first protrusion does not overlap the second protrusion in a direction in which the first protrusion extends,
wherein the second protrusion does not overlap the first protrusion in a direction in which the second protrusion extends.

9. The light route control member of claim 1, wherein the partition wall unit includes an inclined surface having a first inclination angle,
wherein the protrusion includes an inclined surface having a second inclination angle,
wherein the second inclination angle is less than or equal to 5 times the first inclination angle.

10. A display device comprising:
a display panel; and
a light route control member disposed on the display panel,
wherein the light route control member comprises:
a first substrate;
a first electrode disposed on an upper surface of the first substrate;
a second substrate disposed on the first substrate;
a second electrode disposed on a lower surface of the second substrate; and
a light conversion unit disposed between the first electrode and the second electrode,
wherein the light conversion unit includes a partition wall unit and a receiving unit that are alternately disposed,
wherein the receiving unit includes a dispersion and a plurality of light absorbing particles dispersed in the dispersion,
wherein at least one protrusion is disposed inside the receiving unit,
wherein the protrusion is disposed to extend in a direction different from a direction in which the partition wall unit extends.

11. The light route control member of claim 1, wherein a height of the protrusion is different from a height of the partition wall unit.

12. The light route control member of claim 11, wherein the height of the protrusion is smaller than the height of the partition wall unit.

13. The light route control member of claim 12, wherein a length of the protrusion is equal to a width of the receiving portion.

14. The light route control member of claim 1, wherein a height of the protrusion and a height of the partition wall unit are the same,
wherein a length of the protrusion is the same as a width of the receiving unit, and
wherein the protrusion includes an opening area.

15. The light route control member of claim 14, wherein a height of the opening area is 50% or less of the height of the protrusion,
wherein a width of the opening region is 10% to 50% of the width of the receiving unit.

16. The light route control member of claim 1, wherein a height of the protrusion is the same as a height of the partition wall unit,
wherein a length of the protrusion is smaller than a width of the receiving unit.

17. The light route control member of claim 1, wherein the light absorbing particles move according to an application of voltage.

18. The display device of claim 10, wherein a height of the protrusion is smaller than a height of the partition wall unit.

19. The display device of claim 10, wherein a height of the protrusion and a height of the partition wall unit are the same,
wherein a length of the protrusion is the same as a width of the receiving unit,
wherein the protrusion includes an opening area,
wherein a height of the opening area is 50% or less of the height of the protrusion, and
wherein a width of the opening region is 10% to 50% of the width of the receiving unit.

20. The display device of claim 10, wherein a height of the protrusion is the same as a height of the partition wall unit,
wherein a length of the protrusion is smaller than a width of the receiving unit.
